(19) United States
(12) Patent Application Publication
(10) Pub. No.: US 2021/0095148 A1
(43) Pub. Date: Apr. 1, 2021

(54) Ink Compositions

(71) Applicant: Domino Printing Sciences Plc, Cambridge Cambridgeshire (GB)

(72) Inventors: Mary Thomson, Cambridge Cambridgeshire (GB); Andrew Kyriacou, Cambridge Cambridgeshire (GB)

(21) Appl. No.: 16/954,169

(22) PCT Filed: Dec. 14, 2018
(86) PCT No.: PCT/EP2018/084912

§ 371 Date: Jun. 16, 2020

(30) Foreign Application Priority Data
Dec. 15, 2017 (GB) 1721063.4

(51) Int. Cl. C09D 11/328; C09D 11/14

(52) U.S. Cl. CPC C09D 11/328; C09D 11/14

(57) ABSTRACT

Provided is an inkjet composition for printing an indelible colorant onto a substrate. Also provided is a method of printing using the inkjet composition, and a printed substrate obtainable and obtained from the method of printing. The inkjet composition has an indelible colorant, one or more solvents, and a binder. The migration distance of the indelible colorant in the substrate is less than 0.85 mm after 7 days at 25° C. The composition may be used to provide indelible markings in the surface of the substrate, and these markings do not significantly disperse over time.

### RELATED APPLICATION

The present case claims priority to, and the benefit of, GB 1721063.4 filed on 15 Dec. 2017 (15/12/2017), the contents of which are hereby incorporated by reference in their entirety.

### FIELD OF THE INVENTION

The present invention provides an inkjet composition for printing an indelible colorant onto a substrate. Also provided is a method of printing using the inkjet composition, and a printed substrate obtainable and obtained from the method of printing.

### BACKGROUND

Inkjet ink compositions for printing irremovable marks on substrates are known.

U.S. Pat. No. 9,260,617 describes an inkjet ink composition for printing a double layer print on a substrate. The composition is provided with a surface colorant which locates to the top of the print in the double layer. The composition is also provided with a hydrophobic colorant which locates to the bottom of the print in the double layer. It is said that the hydrophobic colorant stains the substrate onto which the composition is printed.

A substantial portion of the hydrophobic colorant is said to reside in the bottom print. A substantial portion of the surface colorant is said to reside in the top print. However, U.S. Pat. No. 9,260,617 does not disclose or exemplify how the distribution of the surface colorant or the hydrophobic colorant between the print layers may be established.

U.S. Pat. No. 9,260,617 notes that the top of the print is not resistant to removal, and this layer, together with the surface colorant, may be removed with, for example, organic solvent. However, the hydrophobic colorant is shown to be resistant to removal, and is shown to have good resistance to physical and chemical stress.

In the worked examples, U.S. Pat. No. 9,260,617 describes the preparation and use of an inkjet ink composition containing Solvent Blue 97 and Solvent Red 23 as hydrophobic colorants, and these colorants are used together with either a Solvent Black 29 or Pigment Black 7 surface colorant.

Whilst U.S. Pat. No. 9,260,617 notes that the use of a hydrophobic colorant together with an appropriate hydrophobic colorant carrier can assist the staining of the substrate, there is no detailed discussion about the distribution of the hydrophobic colorant in the substrate, nor is there any mention of changes in the distribution of the colorant over time.

The present inventors have found that the distribution of a printed indelible dye may change over time, for example within the substrate and also between the printed top layer and the substrate. The inventors have found that the movement, such as diffusion, of a colorant over time leads to a blurring of a printed mark, and therefore a loss in resolution.

The present invention therefore considers the problems associated with changes in colorant distribution over time. The inventors have found that certain types of colorant have limited movement within the substrate after printing, and therefore such colorants are useful for printing marks that retain their resolution over time.

The inventors have also found that the penetration of the indelible dye into the substrate may be affected by factors other than the choice of solvent for the inkjet composition, and the penetration of an indelible colorant into the substrate may be improved by manipulation of the other properties of the ink composition.

### SUMMARY OF THE INVENTION

In a general aspect the present invention provides an inkjet composition for printing an indelible colorant onto a substrate.

The composition may be used to provide indelible markings in the surface of the substrate, and these markings do not significantly disperse over time, such as over a period of 7 days, 10 days, 14 days or more. Thus, markings printed using the compositions of the invention retain their resolution over time.

Accordingly, in a first aspect of the invention there is provided an inkjet composition for printing onto a substrate, the composition comprising an indelible colorant, one or more solvents, and a binder, optionally also containing a plasticiser and/or a conductivity additive, wherein the migration distance of the indelible colorant in the substrate such as LDPE is less than 0.85 mm after 7 days at 25° C. Preferably, the indelible colorant does not predominately reside in the substrate.

The migration distance refers to the spread of the indelible colorant from the boundary of the original point of deposition through the surface of the substrate to an area of the substrate that did not contain the original printed deposition, often referred to as blurring.

In a preferred embodiment, the indelible colorant is a polyaromatic colorant, such as an azo dye or an anthraquinone dye.

The indelible colorant may have at least two aryl groups, and preferably the indelible colorant contains at least three aryl groups. The most energetically favourable configuration for the indelible colorant may be a form where the at least two aryl groups are not in a planar arrangement. Thus, the at least two aryl groups may adopt a skewed or twisted configuration as the most energetically favourable arrangement.

In some embodiments, the indelible colourant may have a molecular weight greater than 300, for example greater than 330, preferably greater than 350.

In some embodiments the indelible colorant may have a conformational energy barrier from its lowest energy conformation to a planar conformation of greater than 1000 kJ/mol, preferably greater than 2500 kJ/mol and even more preferably greater than 4000 kJ/mol.

Conformational energy barriers may be calculated using a molecular mechanics force field by calculating the energy of the lowest energy conformation and the energy of the planar conformation for a particular dye. The difference between these two values is the conformation energy barrier. For example, the values may be calculated using the program “Avogadro” and the molecular mechanics method “universal force field”.

The indelible colorant may be selected from the group consisting of Solvent Black 3, Solvent Blue 97, Solvent Blue 104, Solvent Red 23, Solvent Red 24, Solvent Red 27, Disperse Red 60 or 1-(4-Dodecylanilino)anthraquinone.

In one embodiment, the indelible colorant is not Solvent Blue 97 or Solvent Red 23, or a combination thereof, for example where these indelible colorants are used together with a top colorant that is selected from Solvent Black 29 or Pigment Black 7.

In a preferred embodiment, the inkjet composition further comprises a top colorant, such as Solvent Black 27. The top colorant is a dye that is generally incapable of penetrating the substrate, and therefore remains in the printed layer that is printed on the surface of the substrate. The top colorant may be a metal complex dye or a pigment-based colorant.

It is proposed that for a dye to migrate on a substrate it should adopt a planar configuration. For example, there are no C═C double bonds or transition metal centre which prevent the dye molecule from adopting a planar configuration.

In the present case, the indelible dye is non-ionic and preferably has a lowest energy conformation that is non-planar. Once in the substrate, the larger the energy barrier to achieving a planar configuration, the less time the dye spends in this state, the less it can move, and the less the blurring. In this way the indelible dye has a reduced migration distance and so exhibits less blurring.

The present inventors have also found that penetration of the indelible colorant into the substrate may be hindered where the Tg value of the binder or a binder-plasticizer combination is high. The inkjet composition typically comprises a polymer binder or a binder-plasticizer combination having a relatively low Tg.

The polymer binder may be provided together with a plasticiser, and the binder-plasticizer combination may provide a relatively low Tg. In this way, higher Tg binders may be used in the ink compositions and provide the desired penetration of the substrate by the indelible colorant.

The Tg value of the polymer binder or the binder-plasticizer combination may be 25° C. or less, preferably the Tg value may be 12° C. or less.

The Tg value of the polymer binder or the binder-plasticizer combination may be greater than −50° C., preferably the Tg value may be greater than −20° C.

The ink composition is compatible with the components of an inkjet printer, and more particularly a continuous inkjet printer. The ink composition is suitable for application directly onto products and/or product packaging to achieve high quality images.

In a second aspect there is provided a method of printing, the method comprising the step of printing a composition according to a first aspect of the invention onto a substrate, and permitting the composition to dry.

The method of printing may be an inkjet method of printing, wherein the method comprises directing a stream of droplets of any of the ink composition of the invention on to a substrate and allowing the ink droplets to dry, thereby printing images on the substrate.

The substrate may be selected from LDPE, HDPE, polypropylene, PET, nylon or PVdC, such as LPDE. Preferably, the substrate is a polyethylene substrate such as LDPE or HDPE.

In one embodiment, the inkjet composition for printing is not a composition comprising methyl ethyl ketone (MEK), ethanol, a cellulose acetate butyrate binder, a terpene phenolic ester, a ketone-aldehyde condensation resin, Solvent Blue 104 and Solvent Black 27.

In one embodiment, the inkjet composition for printing is not a composition comprising methyl ethyl ketone (MEK), ethanol, CAB-553-0.4, Dertophene T, Tego Variplus CA, Citroflex A4, Tego Glide 410, Tytan AP100, LiNO3, Duasyn Black-A-RG (Solvent Black 27) and Solvaperm Blue 2B (Solvent Blue 104). In some cases, the inkjet composition for printing is not a composition comprising methyl ethyl ketone (MEK) at 74.88 wt %, ethanol at 8.32 wt %, CAB-553-0.4 at 5.30 wt %, Dertophene T at 1.00 wt %, Tego Variplus CA at 0.30 wt %, Citroflex A4 at 2.80 wt %, Tego Glide 410 at 1.00 wt %, Tytan AP100 at 3.00 wt %, LiNO₃ at 0.65 wt %, Duasyn Black-A-RG (Solvent Black 27) at 2.25 wt % and Solvaperm Blue 2B (Solvent Blue 104) at 0.50 wt %. Dertophene T is a Terpene phenolic ester of approx. Mw of 700, has a Tg of 48° C. Tego Variplus CA is a ketone-aldehyde condensation resin, has a Tg of 75° C. CAB553-0.4 is a cellulose acetate butyrate binder with a Tg of 136° C.

In a third aspect of the invention there is provided a printed deposit, the printed deposit obtained or obtainable from the method of the second aspect of the invention. Preferably, wherein the indelible colorant does not predominately reside in the substrate.

In one embodiment, the printed deposit is not a printed deposit obtained or obtainable from printing an inkjet composition comprising methyl ethyl ketone (MEK), ethanol, a cellulose acetate butyrate binder, a terpene phenolic ester, a ketone-aldehyde condensation resin, Solvent Blue 104 and Solvent Black 27 wherein the substrate is optionally a Tetra Pak substrate.

In one embodiment, the printed deposit is not a printed deposit obtained or obtainable from printing an inkjet composition comprising methyl ethyl ketone (MEK), ethanol, CAB-553-0.4, Dertophene T, Tego Variplus CA, Citroflex A4, Tego Glide 410, Tytan AP100, LiNO3, Duasyn Black-A-RG (Solvent Black 27) and Solvaperm Blue 2B (Solvent Blue 104) wherein the substrate is optionally a Tetra Pal substrate. Dertophene T is a Terpene phenolic ester of approx. Mw of 700, has a Tg of 48° C. In some cases, the printed deposit is not a printed deposit obtained or obtainable from printing an inkjet composition comprising methyl ethyl ketone (MEK) at 74.88 wt %, ethanol at 8.32 wt %, CAB-553-0.4 at 5.30 wt %, Dertophene T at 1.00 wt %, Tego Variplus CA at 0.30 wt %, Citroflex A4 at 2.80 wt %, Tego Glide 410 at 1.00 wt %, Tytan AP100 at 3.00 wt %, LiNO₃ at 0.65 wt %, Duasyn Black-A-RG (Solvent Black 27) at 2.25 wt % and Solvaperm Blue 2B (Solvent Blue 104) at 0.50 wt %. Tego Variplus CA is a ketone-aldehyde condensation resin, has a Tg of 75° C. CAB553-0.4 is a cellulose acetate butyrate binder with a Tg of 136° C.

These and other aspects and embodiments of the invention are described in further detail below.

### FIGURES

FIG. 1 shows a drawdown of Example 6.

FIG. 2 shows a drawdown of Example 10.

FIGS. 3 shows images of the sample prints for Example 6. FIG. 3(a) is the sample immediately after printing. FIG. 3(b) is the sample after 7 days at 25° C. FIG. 3(c) is a microscope image of the sample after 3 weeks at 25° C.

FIGS. 4 shows images of the sample prints for Example 10. FIG. 4(a) is the sample immediately after printing. FIG. 4(b) is the sample after 7 days at 25° C. FIG. 4(c) is a microscope image of the sample after 3 weeks at 25° C.

### DETAILED DESCRIPTION OF THE INVENTION

A typical inkjet composition of the present invention is a composition containing an indelible colorant. The indelible colorant is a colorant that is capable of penetrating into a substrate onto which it is printed, and does not significantly migrate within that substrate after printing, such as the migration distance of the indelible colorant in the substrate such as LDPE is less than 0.85 mm after 7 days at 25° C. Preferably, the indelible colorant does not predominately reside in the substrate.

The migration distance may preferably be less than 0.7 mm after 7 days at 25° C. and even more preferably less than 0.65 mm after 7 days at 25° C.

As used herein, the term migrate or migration distance refers to the spread of the indelible colorant from the boundary of the original point of deposition through the surface of the substrate to an area of the substrate that did not contain the original printed deposition, often referred to as blurring. The term penetration refers to the movement of the indelible colorant into the substrate below the original printed image.

The migration distance is measured by evaluating the blurring of the indelible colorant by migration (and colour change) into an uncoated area of the substrate. This may be done by providing drawdowns, for example with a drop height of approximately 24 μm with half of the substrate covered with tape (to give a sharp edge to the ink coverage). The substrate may be a blank White Tetra Pak Aseptic multi-material food packaging substrate which is a 10-12 μm layer of LDPE on top of the white paper. The ink may be applied to the substrate using a 24 μm draw down bar.

The drawdowns can then be placed in a 25° C. chamber for 7 days. Images of the drawdowns may be scanned using a high resolution scanner, for example at 2400 dpi. The scanned images may be analysed using the QEA software (https://www.qea.com/).

The L*a*b* values can be measured at 0.02 mm increments from the edge of the ink code into the blank substrate and the colour change ΔE can be calculated according to equation 1:

ΔE*_{ab}=\sqrt{(L*₂−L*₁)²+(a*₂−a*₁)²+(b*₂−b*₁)²} (Equation 1)

ΔE can be calculated at each point vs the blank substrate (at 1.6 mm away from the edge of the coating). The colour changes can then be analysed and the distance at which the colour change dropped below ΔE=1 is taken as the point where migration stopped.

ΔE=1 is chosen as the limit for migration as this is the point where colour change is no longer considered visual to the naked eye (see, for example: Choudhury, A. K. R., “Principles of Colour and Appearance Measurement Volume 2: Visual Measurements of Colour. Colour Comparison and Management.”, Woodhead Publishing, 2014; R. F. Witzel, R. W. Burnham, and J. W. Onley, “Threshold and suprathreshold perceptual color differences,” J. Opt. Soc. Am. 63, 615-625 (1973); and Mokrzycki, W. S., Tatol, “Color difference Delta E—A survey”, M. Machine Graphics and Vision, 20, (4), 2011, 383-412).

The compositions of the present invention are typically for use in printing onto substrates selected from LDPE, HDPE, polypropylene, PET, nylon or PVdC, such as LPDE. Thus, it follows that the indelible colorant is capable of penetrating into such substrates.

The composition may be printed onto a substrate, for example using standard inkjet printing methods. Suitable printing methods that may be used are continuous inkjet printing (CIJ) or drop on demand printing process such as piezo inkjet printing (PIJ), valve inkjet printing (VIJ) and thermal inkjet printing (TIJ).

The printing process provides a printed layer on the surface of the substrate, which printed layer can contain the indelible colorant and a top colorant, where a top colorant is used. The printing process permits the indelible dye to penetrate into the surface of the substrate. Thus, indelible dye may be located in both the substrate and the printed layer.

The printed layer may be removable, for example by physical or chemical treatment. Such removal may be unintentional, for example where the mark is rubbed off in transit or in handling, or the removal of the printed layer may be a deliberate act to remove the marking information. Here, the indelible dye that has penetrated the substrate remains, and therefore the ink composition may be used as a security device that retains the marking information despite the removal of the top layer.

Thus, the printing of the indelible colorant onto the substrate, and the penetration of that colorant into the substrate provides a security feature for the printed substrate.

U.S. Pat. No. 9,260,617 describes inkjet ink compositions having a surface colorant for a top print layer, and a hydrophobic colorant for penetration into a substrate. Large numbers of example colorants are given for each. The worked examples of U.S. Pat. No. 9,260,617 describe the use of Solvent Blue 97 and Solvent Red 23, and a combination thereof

Typically, the surface colorant is metal complex dye or a pigment-based colorant. In the present invention these surface colorants may also be used as a top colorant in an embodiment composition of the invention.

However, U.S. Pat. No. 9,260,617 does not particularly discuss the movement of the hydrophobic colorant from the printed layer into the substrate, nor is there any understanding of how the intrinsic properties of the dye influence penetration. Furthermore, U.S. Pat. No. 9,260,617 does not consider or acknowledge the migration of the colorant in the substrate, and there is no teaching that would allow the skilled person to address this problem.

U.S. Pat. No. 9,260,617 does not identify a class of indelible dyes having minimal migration into a substrate such as LDPE. This is now shown by the present case. Further, U.S. Pat. No. 9,260,617 does not disclose a printed substrate where a substantial portion of the indelible colorant is not in the substrate.

U.S. Pat. No. 7,432,316 describes inkjet ink compositions that have a colourant for migration into a substrate. The inks in U.S. Pat. No. 7,432,316 have at least two colourants, a urethane resin and a thermoplastic resin. The inks in U.S. Pat. No. 7,432,316 are particularly for use in printing on wires and are particularly described for withstanding heated or harsh environments.

The first colourant in U.S. Pat. No. 7,432,316 is chosen to migrate substantially into the substrate and is said to blur and fade such that the printed image is no longer legible. The second colorant is used that has a slower migration rate and thus can be legible for a longer period of time. The second colourant is also said to blur and fade.

U.S. Pat. No. 7,432,316 does not identify a class of indelible dyes having minimal migration into a substrate such as LDPE. This is now shown by the present case. Further, U.S. Pat. No. 7,432,316 does not disclose a printed substrate where a substantial portion of the indelible colorant is not in the substrate.

### Inkjet Composition

Preferably the inkjet composition described herein has a viscosity of about 0.5 to 7 mPa·s, more preferably from 1 to 5.5 mPa·s at 25° C. Preferably the ink composition described herein has a viscosity of less than 7 mPa·s, more preferably less than 5.5 mPa·s at 25° C. Preferably the ink composition described herein has a viscosity of greater than 0.5 mPa·s, more preferably greater than 1 mPa·s, even more preferably greater than 3 mPa·s at 25° C. The viscosity of the ink composition may be in a range with the upper and lower limits selected from the amounts described above. The viscosity of the composition may be measured using a viscometer such as a Brookfield DV-II+ viscometer.

Preferably the ink composition as described herein has a surface tension of from 20 to 50 mN/m, more preferably from 25 to 40 mN/m at 25° C. The surface tension of the composition may be measured using equipment such as a du Nouy ring tensiometer or using the pendant drop method on a KSV Cam 200 optical tensiometer.

The ink composition preferably has or contains a binder or binder-plasticizer combination having a T_{g} of 25° C. or less, more preferably the Tg value may be 12° C. or less.

The ink composition preferably has or contains a binder or binder-plasticizer combination having a T_{g} greater than −50° C., preferably the Tg value may be greater than −20° C.

The ink composition preferably has or contains a binder or binder-plasticizer combination having a T_{g} of from −50° C. to 25° C., more preferably the Tg value may be from −20° C. to 12° C.

It is envisaged than any combination of the upper and lower limits for the Tg value of the binder or binder-plasticizer combination may be combined to form a range of Tg values suitable for the ink composition of the present invention.

In one embodiment, the inkjet composition for printing is not a composition comprising methyl ethyl ketone (MEK), ethanol, a cellulose acetate butyrate binder, a terpene phenolic ester, a ketone-aldehyde condensation resin, Solvent Blue 104 and Solvent Black 27.

In one embodiment, the inkjet composition for printing is not a composition comprising methyl ethyl ketone (MEK), ethanol, CAB-553-0.4, Dertophene T, Tego Variplus CA, Citroflex A4, Tego Glide 410, Tytan AP100, LiNO3, Duasyn Black-A-RG (Solvent Black 27) and Solvaperm Blue 2B (Solvent Blue 104). Dertophene T is a terpene phenolic ester of approx. Mw of 700, has a T_{g} of 48° C. Tego Variplus CA is a ketone-aldehyde condensation resin, with a T_{g} of 75° C.

### Indelible Colorants

The ink composition of the present invention comprises an indelible colorant, for example a dye or a pigment. The indelible colorant is a colorant that penetrates into the substrate after, and optionally to a limited extent during, the printing process. In some cases, penetration occurs entirely after the printing process.

Typically, an indelible colorant is used together with a substrate that is capable of accepting the colorant into its surface. Typically, the substrate is a polyethylene substrate, such as LDPE, which is frequently used in packaging, for example in the food and drinks industries.

The indelible colorant for use in the present invention is a colorant that has limited movement in the substrate once it has been printed and has penetrated into that substrate. The movement of an indelible colorant can be monitored over time, as described herein. The movement of a dye in a printed mark may be observable by eye as a blurring of the printed mark as the dye migrates through the substrate to expand the original printed mark. A loss of mark resolution is therefore observed.

The migration of the dye may also be measured by optical microscopy, taking into account optical density, as explained in the present case. Measurements by optical microscope require visual determination of the point of change in contrast.

The migration, or lack of colorant migration, in the substrate may be considered at least 1 day, 7 days, 10 days or 14 days after printing. The substrate may be held at ambient temperature and pressure over this time, such as at 25° C. and at 101.3 kPa.

The movement of the indelible dye may be considered with respect to the change in the distribution, such as spread, of dye in a marking, such as a circular marking over the specified time. In some of the worked examples of the present case, a circular marking is printed onto the substrate, which results in circular marking of the indelible dye in the substrate. The spread of the circular marking in the substrate, such as an increase in the diameter of the marking, is measured and compared with the marking as originally printed. In other worked examples of the present case, a drawdown is provided having a flat edge of ink and the spread is measured with QEA software (as described in detail herein).

A drawdown is a sample made by depositing a layer of the mixed ink on the surface of a substrate using a smooth-edged knife or drawdown bar or rod. A drawdown bar can be used to provide a specified ink thickness on the substrate. In the worked examples of the present case a 24 μm drawdown rod (or drawdown bar) is used to provide an ink thickness of approximately 24 μm which is estimated to the height of ink in a printed drop. Drawdowns are often used to mimic large printed areas.

The measurement of the dye distribution may be with optical microscope or appropriate measurements of the markings by, for example, digital imaging software. An appropriately coloured (such as white) substrate may be chose to provide suitable contrast for the measurements.

The movement of the dye may be considered within a LDPE substrate onto which a composition is printed.

The indelible dye is not required to, and typically does not, wholly penetrate into the surface of the substrate. Thus, the indelible dye may be distributed in both the surface of the substrate and the printed layer on the surface of the substrate.

Indeed, the inventors have found that it is not necessary for the entire amount of the indelible dye to penetrate into the surface of the substrate. The inventors have found that sufficiently visible and permanent markings may be obtained where a minor proportion of the indelible dye is provided in the substrate. Thus, it is not necessary to achieve a total penetration of the indelible dye into the substrate. Accordingly, a substantial portion of the indelible dye is not present within the substrate, for example as measured at 1 day (24 hours), 7 days or 14 days after printing.

The distribution of an indelible dye between the substrate and the printed layer may be determined by optical means, measuring the optical density of the printed substrate before and after the printed layer is removed, and taking into account the optical characteristics of the substrate itself. From these measurements it is possible to determine the distribution of the indelible dye. In some of the examples of the present case, the distribution of the indelible dye is measured using a drawdown sample rather than a printed sample.

The indelible dye may penetrate the substrate after 1 hour by less than 75%, for example less than 65%, for example less than 55%.

The indelible dye may penetrate the substrate after 1 day by less than 85%, for example less than 75%, for example less than 65%.

The indelible dye may penetrate the substrate after 1 week by less than 95%, for example less than 75%, for example less than 65%, for example less than 50%.

Penetration of the substrate may be quantitatively measured as follows. Drawdowns of the ink may be made, for example using a 24 μm drawdown bar on a blank Tetra Pak material. The samples can be placed in a 25° C. chamber and left for a fixed amount of time depending on the measurement taken (1 hour, 1 day or 1 week).

The top layer of ink can then be removed using MEK (several wipes) and the colour measured using an x-rite densiometer. The L*a*b* values and the optical density may be recorded in triplicate at three different positions and averaged.

Colour change can be calculated with respect to the blank substrate (measured in the same way) according to equation:

ΔE*_{ab}=\sqrt{(L*₂−L*₁)²+(a*₂−a*₁)²+(b*₂−b*₁)²} (Equation 1)

Optical density change can be calculated with respect to the top, unaltered ink film according to equation 2:

$$Optical Density Change = \frac{\begin{matrix}Optical density of top code - \\ Optical density of tampered code\end{matrix}}{\begin{matrix}Optical density of top code - \\ Optical density of blank substrate\end{matrix}} \qquad ( Equation 2 )$$

It is known from these optical measurements that top colorant, where present, does not significantly penetrate into the substrate, and instead remains predominantly located in the printed layer.

In a preferred embodiment, the indelible colorant is not substantially present in the substrate. Thus, the indelible colorant may be substantially present in the printed layer.

In one embodiment, the indelible colorant is selected from the group consisting of Solvent Black 3, Solvent Blue 97, Solvent Blue 104, Solvent Red 23, Solvent Red 24, Solvent Red 27 and 1-(4-Dodecylanilino)anthraquinone (CAS 42887-26-3). Preferably, the indelible colorant is selected from the group consisting of Solvent Black 3, Solvent Blue 97 and Solvent Blue 104.

The present inventors have found that the movement of an indelible colorant through the surface of the substrate may be inhibited or prevented where a colorant is capable of adopting a non-planar configuration, such as a skewed or twisted configuration, whilst located within the substrate.

Without wishing to be bound by theory, the inventors believe that colorants that are able to adopt a planar structure whilst located in the substrate are capable of movement through the substrate. Thus, the use of such colorants is associated with a deleterious spread of those colorants in the substrate after printing.

The inventors believe that colorants that are able to adopt a non-planar structure, such as a skewed structure, having a reduced ability to move through the substrate, for example owing to steric interactions between the non-planar form and the substrate that limit or prevent movement of that colorant through the network of the substrate.

Many colorants are capable of adopting both planar and non-planar configurations, for example by relative movement of groups within the colorant by bond rotation. Where there is no barrier to rotation, these groups may rotate freely, and the configuration adopted by the colorant will be the most energetically favourable form. For many systems this may be a planar form. Here, the planar form is energetically favourable, owing, for example, to a planar arrangement of aromatic groups with the indelible colorant. Such colorants are to be avoided in the present case.

Energies can be calculated using a molecular mechanics force field. For example, the values may be calculated using the program “Avogadro” and the molecular mechanics method “universal force field”.

Using this method, for example, Solvent Blue 104 has an energy minimum of 625 kJ/mol. The energy minimum configuration for Solvent Blue 104 is a non-planar configuration. Solvent Blue 104 in a planar configuration is 4572 kJ/mol, giving an energy barrier of 4127 kJ/mol for Solvent Blue 104 to adopt the planar configuration from the energy minimum configuration.

Solvent Green 3 has a similar structure to Solvent Blue 104 except that Solvent Green 3 does not have ortho methyl groups on the phenyl rings. Solvent Green 3 has an energy minimum of 486 kJ/mol. The energy minimum configuration for Solvent Green 3 is a non-planar configuration. Solvent Green 3 in the planar configuration is 786 kJ/mol, giving a (lower) energy barrier of 300 kJ/mol for Solvent Green 3 to adopt the planar configuration from the energy minimum configuration compared to Solvent Blue 104.

In some colorants, the free rotation of groups may be limited, and the planar form may be energetically unfavourable, for example owing to steric clashes between the rotatable groups. The colorant may therefore typically adapt a skewed form, as this is the most energetically favourable form. Such colorants may be used to advantage in the compositions of the present case.

Colorants for use in the present case are typically those colorants possessing two or more aromatic groups, and more preferably those colorants having three or more aromatic groups. The most energetically favourable configuration for the indelible colorant may be a form where the at least two aryl groups are not in a planar arrangement. Thus, the at least two aryl groups may adopt a skewed or twisted configuration as the most energetically favourable arrangement.

Thus the inventors have found that suitable indelible dyes for the present invention include Solvent Black 3, Solvent Blue 97, Solvent Blue 104, Solvent Red 23, Solvent Red 24, Solvent Red 27, Disperse Red 60 and 1-(4-Dodecylanilino)anthraquinone.

One or each of the aromatic groups may be substituted at positions that limit or prevent the adoption of a planar arrangement within the indelible dye.

A colorant may contain a first aromatic group, such as a phenyl group, that is connected to a second aromatic group, where the point of connection on the first aromatic group may be referred to the 1-position. The first aromatic group may be directly connected to the second aromatic group or indirectly via a linking group.

The first aromatic group is optionally substituted, such as disubstituted. The second aromatic group is optionally substituted.

Where the first aromatic group is directly connected to the second aromatic group, there is a covalent bond between an aromatic ring atom of the first aromatic group and a covalent bond between an aromatic ring atom of the second aromatic group.

Where the first aromatic group is connected to the second aromatic group via a linking group, this may be a short linking group, which may be one or two atoms separation between groups. The group may be —N(H)—, —O— or —N═N—, for example. The distance is sufficiently short that any substituents on aromatic group, such as the first aryl group, come into close proximity with the second aromatic group, and any of its substituent groups.

The first aromatic group may be ortho-substituted. One or both, preferably both, of the aromatic ring atoms neighbouring the ring 1-position may be substituted. Other substituents may be present at other ring positions.

The first aromatic group is preferably a phenyl group. Here, one or both, such as both, of the 2- and 6-positions (the ortho-positions) of the phenyl group are substituted.

The first aromatic group may be a multicyclic aromatic group, having two or more fused aromatic rings. For example, the first aromatic group may be naphthyl group. Here, the first aromatic group may be regarded a phenyl group having an ortho-substituent, with that substituent being the part of the second aromatic benzene ring that is fused to the phenyl group.

A substituent may be any non-hydrogen group. Each substituent preferably contains two or more atoms, such as three or more atoms. Each substituent may be alkyl, such as methyl or ethyl, amino, hydroxyl, alkoxy, mercapto, nitro or a halide.

For example, Solvent Blue 97 and Solvent Blue 104 contain phenyl groups that are 2,6-disubsituted with alkyl, such as methyl-disubstituted and ethyl disubstituted.

Other substituents may be present at other ring positions. For example, the 4-position may be substituted, as seen with many anthraquinone colorants, such as Solvent Blue 97 and Solvent Blue 104, where each phenyl group is substituted with methyl at position 4.

The indelible dye may be an anthraquinone dye. Such dyes typically contain an anthraquinone group that is substituted at the 1-, 2- and/or 4-positions with a group independently selected from an aminoaryl and an oxyaryl group, such as an aminophenyl or oxyphenyl group. Here, the anthraquinone group may be regarded as the second aromatic group. Each aryl group may be regarded as a first aromatic group, such as described above, that is connected to the second aromatic group via a linker, such as —NH—, —O— or —N═N—.

The inventors have found that where the first aryl group does not possess suitable substituents, such as where the first aryl group is lacking ortho-substituents, the colorant may be in a substantially planar configuration and can show significant movement within the substrate after printing. Thus, the present inventors have found that Solvent Green 3, Solvent Violet 13, Solvent Blue 35 and Solvent Orange 7 are not suitable for use. Each of these indelible colorants possesses an aminophenyl group that does not possess ortho-substituents (2- and 6-substituents) to the amino functionality.

In some cases, where the first aryl group is not substituted at the 2- or 4-position, the second aryl group (i.e. the anthraquinone group) may provide sufficient steric hindrance such that the aryl groups adopt a skewed or twisted configuration as the most energetically favourable arrangement.

For example, Disperse Red 60 and 1-(4-Dodecylanilino)anthraquinone are anthraquinon dyes that contain a first aryl group that is not substituted at the 2- or 4-position. These dyes adopt a skewed or twisted configuration as the most energetically favourable arrangement and are useful indelible dyes for the present invention. In the case of Disperse Red 60, the anthraquinone group is ortho substituted with an amine.

The indelible colorant may be an azo dye, such as a diazo dye. Preferably the azo dye has an azo group that is covalently connected to an aryl group, such as a naphthyl group, and more preferably the azo group is connected to two aryl groups, with each aryl group connected to a nitrogen atom of the azo group.

Where the azo dye is a diazo dye, a first azo group may be connected to two aryl groups, whilst the second azo group may be connected to one aryl group, which aryl group may also be connected to the first azo group. Solvent Black 3 is an example of a diazo dye of this type.

The azo dye may contain a first napthyl group that is connected to phenyl group or a second naphthyl group via the azo group.

The first naphthyl group is connected to an azo group, for example at the 1-position of the naphthyl group. The first naphthyl group may be optionally substituted, such as substituted at the 2-position. For example, the first naphthyl group may be substituted at the 2-position with hydroxyl.

The phenyl group that is connected to the first naphthyl group may be optionally substituted, such as substituted with one or two alkyl groups, and preferably one or two methyl groups. The second naphthyl group that is connected to the first naphthyl group may be optionally substituted.

The phenyl group and the second naphthyl group may be optionally further substituted with a second azo group. That second azo group may connected to a second phenyl group or a third naphthyl group, such as a second phenyl group.

The second phenyl group may be optionally substituted, such as substituted with one or two alkyl groups, and preferably one or two methyl groups.

The second naphthyl group that is connected to the first naphthyl group may be optionally substituted.

The present inventors understand that azo dyes may adopt a configuration where the groups that are provided either side to the azo functional group, such as aryl groups together with the azo group itself, are not provided in a planar configuration. Although a planar arrangement increase the aromaticity of the overall system, the presence of the fused aromatic rings creates an energy barrier for the planar configuration which thereby favours a non-planar form.

Examples of azo dyes for use in the present invention include Solvent Black 3, Solvent Red 23, Solvent Red 24 and Solvent Red 27.

Preferably, the indelible colorant is present in less than 25 wt % based on total weight of the ink composition, more preferably less than 15 wt %, such as less than 10 wt %, and even more preferably less than 4 wt %. Preferably, the indelible colorant is present in greater that 0.1 wt %, greeter than 0.5 wt %, or greater than 1 wt % based on total weight of the ink composition.

The indelible colorant may be present in an amount that is in a range with the upper and lower limits selected from the amounts described above. For example, the indelible colorant is present in between 0.1 to 10 wt % based on total weight of the ink composition, more preferably 0.1 to 4 wt %, and most preferably 0.4 to 4 wt % based on total weight of the ink composition.

A combination of indelible colorant may be provided. Where this is the case, each indelible colorant may be provided in an amount as specified above. Alternatively the combined amount of the indelible colorants may be an amount selected from the values given above for a single indelible colorant.

In this way the formulation may have the desired opacity and colour.

The indelible colorant may be selected for its colour, and it may be selected in combination with a top colorant, which is also selected for its colour.

### Top Colorant

The composition of the invention typically also contain a second colorant, which is a top colorant. This dye is for location in the printed layer on the surface of the substrate, and the top colorant does not substantially penetrate into the surface of the substrate. The top colorant may be used together with the indelible dye to provide a dual ink print.

Preferably the composition comprises a top colorant. Here, the top colorant occupies the printed layer on the surface, and indelible dye is provided within the substrate. The indelible dye may also be located together with the top colorant in the printed layer. Sometimes the print may be referred to as a dual layer print, although the reference to a bottom layer is not an entirely accurate description of the location of the indelible dye within the substrate. The indelible dye here penetrates the substrate, with a layer provided on the surface, which layer holds the top colorant typically together with some indelible dye.

The top colorant is a dye that is generally incapable of penetrating the substrate, and therefore remains in the printed layer that is printed on the surface of the substrate. The top colorant may be a metal complex dye or a pigment-based colorant.

The metal complex dye may be selected from Solvent Black 7, Solvent Black 27, Solvent Black 28, Solvent Black 29, Solvent Black 45, Solvent Black 48; Solvent Orange 45, Solvent Orange 54, Solvent Orange 62, Solvent Yellow 25, Solvent Yellow 79; Solvent Red 118, Solvent Red 119, Solvent Red 122, Solvent Red 125, Solvent Red 127, Solvent Red 130, Solvent Red 160, and Solvent Red 233, such as Solvent Black 27 and Solvent Black 29.

The pigment-based colorant may be selected from Pigment Black 7, Pigment Black 23, Pigment Black 28; Pigment Brown 6, Pigment Brown 23, Pigment Brown 24; Pigment Blue 15:1, Pigment Blue 28, Pigment Blue 29, Pigment Blue 36, Pigment Blue 72, Pigment Blue 76; Pigment Green 7, Pigment Green 17, Pigment Green 36, Pigment Green 50; Pigment Violet 2, Pigment Violet 19, Pigment Violet 23; Pigment Red 5, Pigment Red 48:2, Pigment Red 52, Pigment Red 52:2, Pigment Red 57:1, Pigment Red 81, Pigment Red 111, Pigment Red 112, Pigment Red 122, Pigment Red 135, Pigment Red 144, Pigment Red 149, Pigment Red 166, Pigment Red 170, Pigment Red 179, Pigment Red 181, Pigment Red 187, Pigment Red 202, Pigment Red 209, Pigment Red 220, Pigment Red 221, Pigment Red 247, Pigment Red 254, Pigment Red 272; Pigment Orange 13, Pigment Orange 16, Pigment Orange 43, Pigment Orange 60, Pigment Orange 64, Pigment Orange 71; Pigment Yellow 1, Pigment Yellow 13, Pigment Yellow 14, Pigment Yellow 42, Pigment Yellow 53, Pigment Yellow 63, Pigment Yellow 65, Pigment Yellow 83, Pigment Yellow 93, Pigment Yellow 95, Pigment Yellow 109, Pigment Yellow 110, Pigment Yellow 119, Pigment Yellow 138, Pigment Yellow 151, Pigment Yellow 168, Pigment Yellow 180, Pigment Yellow 183, Pigment Yellow 191, and Pigment Yellow 232.

In one embodiment the top colorant is not Solvent Black 29 or Pigment Black 7, for example when the indelible colorant is Solvent Blue 97 or Solvent Red 23.

The top colorant is preferably Pigment Black 7, Solvent Black 27 or Solvent Black 29, such as Solvent Black 27.

Preferably, the top colorant is present in less than 25 wt % based on total weight of the ink composition, more preferably less than 15 wt %, such as less than 10 wt %, and even more preferably less than 4 wt %. Preferably, the top colorant is present in greater that 0.1 wt %, greater than 0.5 wt %, or greater than 1 wt % based on total weight of the ink composition. The top colorant may be present in an amount that is in a range with the upper and lower limits selected from the amounts described above. For example, the top colorant is present in between 0 to 10 wt % based on total weight of the ink composition, more preferably 0.1 to 10 wt %, preferably 0.1 to 4 wt % and most preferably 0.4 to 4 wt % based on total weight of the ink composition.

A combination of top colorants may be provided. Where this is the case, each top colorant may be provided in an amount as specified above. Alternatively the combined amount of the top colorants may be an amount selected from the values given above for a single top colorant.

The top colorant may be selected for its colour, and it may be selected in combination with an indelible colorant, which is also selected for its colour.

In one embodiment, the top colorant is a different colour to the indelible dye. This combination is particularly useful as a security feature of the printed inkjet composition, as a change in colour of the printed mark is indicative of the removal of the top printed layer, which shows tampering or damage to the top layer, by revelation of the alternatively coloured colorant that is provided in the substrate.

The top colorant is predominately located in the printed layer. Thus, the top colorant is substantially absent from the substrate. The distribution of a top colorant may be determined by appropriate optical density measurement such as described herein. For the measurement of top colorant distribution between the printed layer and the substrate, it may be helpful to print a test substrate omitting the indelible colorant, thereby to allow a determination of the penetration of the top colorant into the substrate (which penetration is expected to be insubstantial).

### Solvents

The ink composition may contain an organic solvent or a mixture of organic solvents. Any organic solvent or mixture which can dissolve the colorant is suitable. A solvent may be selected from ketones, alcohols, esters, glycols, glycol ethers or a mixture thereof.

For example, an organic solvent may be selected from acetone, methyl ethyl ketone, methyl propyl ketone, methyl isobutyl ketone, cyclohexanone, ethanol, isopropanol, n-propanol, isobutanol, n-butanol, methyl acetate, ethyl acetate, n-propyl acetate, isopropyl acetate, n-butyl acetate, isobutyl acetate, t-butyl acetate, n-amyl acetate, isoamyl acetate, isobutyl isobutyrate, ethylene glycol, propylene glycol, 1-methoxy-2-propanol and 1-methoxy-2-propyl acetate or a mixture thereof.

The ink composition may also contain water. For example, if present, water may be present at less than 10 wt % based the total weight of the ink composition, preferably water is present at less than 5 wt %.

The composition may be a non-aqueous composition.

Preferably, the organic solvent is present in the composition between 10 to 95 wt %, more preferably 40 to 90 wt %, and most preferably 70 to 90 wt % by weight based on total weight of the ink composition.

Preferably, the organic solvent is present in less than 95 wt % based on total weight of the ink composition, more preferably less than 93 wt % and even more preferably less than 91 wt %. Preferably, the solvent is present in greater than 10 wt % based on total weight of the ink composition, preferably greater than 40 wt %, and even more preferably greater than 70 wt %. The solvent may be present in an amount that is in a range with the upper and lower limits selected from the amounts described above.

A preferred organic solvent for use is a ketone, such as methyl ethyl ketone. Preferably, the ketone, such as methyl ethyl ketone, is present from 10 to 90 wt %, more preferably 50 to 87 wt %, and most preferably 65 to 84 wt % based on total weight of the ink composition.

Preferably, the ketone, such as methyl ethyl ketone, is present in less than 90 wt % based on total weight of the ink composition, more preferably less than 87 wt % and even more preferably less than 84 wt %. Preferably, the ketone, such as methyl ethyl ketone, is present in greater than 10 wt % based on total weight of the ink composition, preferably greater than 50 wt %, and even more preferably greater than 65 wt %. The ketone may be present in an amount that is in a range with the upper and lower limits selected from the amounts described above.

Preferably, when the organic solvent is a mixture, the mixture contains an alcohol, such as a C₁₋₆ alkyl alcohol. For example, ethanol or isopropanol. Preferably, the alcohol is present from 5 to 20 wt %, more preferably 5 to 10 wt %, based on total weight of the ink composition.

Preferably, the alcohol is present in less than 20 wt % based on total weight of the ink composition, more preferably less than 15 wt %. Preferably, the alcohol is present in greater than 5 wt % based on total weight of the ink composition, preferably greater than 7 wt %. The alcohol may be present in an amount that is in a range with the upper and lower limits selected from the amounts described above.

Preferably when the organic solvent is a mixture, the mixture comprises a ketone and an alcohol such as a C₁₋₆ alkyl alcohol. For example, the mixture comprises methyl ethyl ketone and ethanol or isopropanol, such as ethanol.

In the printed deposit the solvent has at least partially evaporated. In this case, it may be that no solvent or only trace amounts of solvent are present in the printed deposit.

### Binders

A binder such as a binder resin may be present in the inkjet composition.

The binder comprises one or more polymers. The binder may be selected from any suitable binder, for example, suitable binders include polyamide resins, polyurethane resins, rosin ester resins, acrylic resins, polyvinyl butyral resins, polyesters, phenolic resins, vinyl resins, polystyrene/polyacrylate copolymers, cellulose ethers, cellulose nitrate resins, polymaleic anhydrides, acetal polymers, polystyrene/polybutadiene copolymers, polystyrene/polymethacrylate copolymers, sulfonated polyesters, aldehyde resins, polyhydroxystyrene resins and polyketone resins and mixtures of two or more thereof.

Preferably, the binder is selected from cellulosic resins, acrylic resins, vinyl resins, polyamides, polyesters, polyvinyl (e.g. polyvinyl butyral (PVB)), and polyurethanes. More preferably, the binder is a cellulosic resin. Even more preferably, the cellulosic resin is cellulose acetate butyrate.

Preferably, the binder has a molecular weight, such as a weight average molecular weight (Mw) between 1,500 and 50,000, more preferably between 10,000 and 50,000 and even more preferably between 15,000 and 50,000. Preferably, the binder has a molecular weight, such as a weight average molecular weight (Mw) of at least 1,500, more preferably at least 10,000 and even more preferably at least 15,000. Preferably, the binder has a molecular weight, such as a weight average molecular weight (Mw) less than 50,000. The binder has a molecular weight, such as a weight average molecular weight (Mw) that is in a range with the upper and lower limits selected from the amounts described above.

In the worked examples of the present case the cellulose binder resin CAB553-0.4 is used. CAB-553-0.4 is shortened to CAB553 in the worked examples.

The present inventors have found that the use of a binder having a relatively low Tg value enhances the penetration of the indelible dye into the substrate. The present inventors have also found that a binder with a high Tg value can be mixed with a plasticizer to provide a mixture with a lowered Tg value. The resulting binder-plasticizer combination can enhance the penetration of the indelible dye.

Thus, in a preferred embodiment the composition comprises a binder or a binder-plasticizer combination having a Tg that is no more than 25° C.

For example, the Tg of the binder or the binder-plasticizer combination may be no more than 12° C.

The binder or binder-plasticizer combination may have a T_{g} greater than −50° C., preferably the Tg value may be greater than −20° C. Lower Tg values can result in sticky inks which can be hard to use.

The binder or binder-plasticizer combination may have a T_{g} of from −50° C. to 25° C., more preferably the Tg value may be from −20° C. to 12° C.

It is envisaged than any combination of the upper and lower limits for the Tg value of the binder or binder-plasticizer combination may be combined to form a range of Tg values suitable for the ink composition of the present invention.

The Tg value for the binder may refer to Tg value for a single polymer binder within the composition.

The Tg value for the binder may refer to the Tg value for a sample of all the polymer components within the inkjet composition, for example where there are a plurality of polymers present in the composition.

The Tg value for the binder-plasticizer combination may refer to Tg value for a single polymer binder and the plasticizer used in the inkjet composition.

The Tg value for the binder-plasticizer combination may refer to the Tg value for a sample of all the polymer components used in the inkjet composition or all of the plasticizers used in the inkjet composition. For example where there a plurality of polymers are used in the composition the Tg value is for a sample of all of the polymer components and the plasticizer.

Without wishing to be bound by theory, the present inventors believe that the movement of the indelible colorant into the substrate is affected by the degree of entanglement in the polymer binder. Where, a polymer has a high degree of chain entanglement it may trap indelible colorant within, thereby preventing the indelible dye from moving from the polymer matrix into the substrate. In contrast, a polymer having a lower degree of chain entanglement does not significantly inhibit the movement of the indelible colorant through its network, and thereby does not significantly impede the penetration of the indelible colorant into the substrate.

The measured Tg value for a polymer binder may be used as an indicator of polymer entanglement. Thus, a polymer binder having a relatively high Tg value may be regarded as a having a high degree of entanglement, and conversely a polymer binder having a relatively low Tg value may be regarded as a having a low degree of entanglement.

Without wishing to be bound by theory, the present inventors believe that the use of a plasticizer can reduce the degree of entanglement of a polymer binder and so reduce the Tg value of the mixture.

Tg was calculated by the Fox equation (° C.). Tg of the binder was taken from information supplied by the supplier and the Tg of the plasticizer was taken from Harte et al (J. Applied Polymer Sci, 127, 2013, “The effect of citrate ester plasticizers on the Thermal and Mechanical properties of poly(DL-lactide)”).

Briefly, the the Fox equation is a formula that can be used to predict the T_{g} of a mixture, often a polymer mixed with a low molecular weight diluent or plasticizer. The Fox equation is shown below where w₁ and w₂ are weight fractions of components 1 and 2, respectively.

$$\frac{1}{{T}_{g}} = \frac{{w}_{1}}{{T}_{g , 1}} + \frac{{w}_{2}}{{T}_{g , 2}} .$$

The influence of Tg on the amount of indelible colorant that penetrates into the substrate may be seen from the optical measurements of a printed ink composition. As described herein, the amount of colorant within a substrate may be determined after removal of the top printed layer (which may contain a top colorant), followed by optical measurements of the exposed substrate with the indelible dye within. Where there is a decrease in the Tg of the polymer binder or binder-plasticizer combination, there is observable an increase in the amount of the indelible dye present in the substrate, as determined by the optical measurements. Conversely, increasing the Tg of the polymer binder or the binder-plasticizer combination is associated with an observable decrease in the amount of indelible dye present in the substrate.

Preferably, the binder has good solubility in the organic solvents commonly used in solvent based inks. For example, the solubility of the binder resin the solvent is from 20 to 100 grams/100 mL at 25° C.

Preferably, the binder is present at from 1.5 to 25 wt % based on total weight of the ink composition, more preferably from 2 to 10 wt % and even more preferably from 4 to 6 wt %.

Preferably, the binder is present in less than 25 wt % based on total weight of the ink composition, more preferably less than 10 wt %, more preferably less than 8 wt % and even more preferably less than 6 wt %. Preferably, the binder is present in greater than 1.5 wt % based on total weight of the ink composition, preferably greater than 2 wt %, and even more preferably greater than 4 wt %. The binder may be present in an amount that is in a range with the upper and lower limits selected from the amounts described above.

### Additives

The ink composition and the printed deposit may contain additional components, such as are common in the art.

Preferably, the ink composition and the printed deposit may further comprise one or more preservatives, humectants, defoamer, surfactants, conductivity additives, wetting agents, adhesion promotion additives, biocides, co-binders, surface tension modifiers and mixtures of two or more thereof.

### Conductivity Additives

Preferably, the ink composition and the printed deposit further comprises a conductivity additive. The conductivity additive may be any conductivity additive known in the art and may be selected from salts of alkali metals, salts of alkaline earth metals or quaternary ammonium salts.

Conductivity additives for ink compositions are well-known in the art, in particular conductivity additives for ink compositions for inkjet inks are well known.

In some cases the conductivity additive is a metal salt. Preferably, the metal salt is selected from lithium nitrate, lithium triflate, potassium hexafluorophosphate, sodium hexafluorophosphate, sodium iodide or potassium iodide. More preferably, the conductivity additive is lithium nitrate (LiNO₃).

In some cases the conductivity additive is an organic salt. Preferably, the organic salt is selected from quaternary ammonium or phosphonium salts. For example, the organic salt may be selected from tetraethylammonium chloride, tetraethylammonium bromide, tetrabutylammonium chloride, tetrabutylammonium bromide, tetrabutylammonium acetate, tetrabutylammonium nitrate, tetrabutylammonium tetrafluoroborate, tetrabutylammonium hexafluorophosphate, tetrabutylphosphonium chloride and tetrabutylphosphonium bromide. A preferred salt in tetrabutylammonium bromide.

Preferably, the conductivity additive is present at from 0.1 to 5 wt % based on total weight of the ink composition.

### Humectants

Preferably, the ink composition and the printed deposit further comprises a humectant.

Suitable humectants include ethylene glycol, 1,3-propanediol, 1,4-butanediol, 1,4-cyclohexanedimethanol, 1,5-pentanediol, 1,6-hexanediol, 1,8-octanediol, 1,2-propanediol, 1,2-butanediol, 1,3-butanediol, 2,3-butanediol, diethylene glycol, triethylene glycol, tetraethylene glycol, polyethylene glycol, dipropylene glycol, polypropylene glycol, glycerol, 1,2,6-hexanetriol, sorbitol, 2-pyrrolidone, 2-propanediol, butyrolacetone, tetrahydrofurfuryl alcohol and 1,2,4-butanetriol and mixtures of two or more thereof. Preferably the humectant is selected from a group consisting of glycerol, tetrahydrofurfuryl alcohol, polypropylene glycol and mixtures of two or more thereof.

The ink composition may comprises approximately a 1:1 ratio of humectant to solvent.

The ink composition may comprise up to 30% by weight of humectants based on the total weight of the composition. More preferably, the ink composition comprises up to 20% by weight of humectants based on the total weight of the composition.

### Preservatives

Preferably, the ink composition and/or the printed deposit further comprises a preservative.

Suitable preservatives include sodium benzoate, benzoic acid, sorbic acid, potassium sorbate, calcium sorbate, calcium benzoate, methylparaben and mixtures of two or more thereof. The preferred preservative is sodium benzoate.

The ink composition may comprise up to 2% by weight of preservative based on the total weight of the composition. More preferably, the ink composition comprises up to 1% by weight of preservative based on the total weight of the composition.

### Surfactants

Preferably, the inkjet ink composition and/or the printed deposit further comprises a surfactant.

Suitable surfactants include anionic, cationic, non-ionic or silicone surfactants and mixtures of two or more thereof. Non-limiting examples of anionic surfactants include alkyl sulphate, alkylaryl sulfonate, dialkyl sulfonate, dialkyl sulphosuccinate, alkyl phosphate and polyoxyethylene alkyl ether sulphate. Non-limiting examples of cationic surfactants include alkylamine salt, ammonium salt, alkylpyridinium salt and alkylimidazolium salt. Non-limiting examples of non-ionic surfactants include polyoxyethylene alkyl ether, polyoxyethylene alkylaryl ether, sorbitan fatty acid ester, polyoxyethylene sorbitan fatty acid ester, polyoxyethylene sorbitol fatty acid ester, glycerine fatty acid ester, a fluorine-containing non-ionic surfactant and a silicon-containing non-ionic surfactant. Non-limiting examples of silicone surfactants include polyether siloxane copolymers. Mixtures of two or more surfactants may be used.

The ink composition may comprise up to 5% by weight of surfactant based on the total weight of the composition. More preferably, the ink composition comprises up to 1 wt % of surfactant based on the total weight of the composition.

### Defoamers

Preferably, the inkjet ink composition and/or the printed deposit further comprises a defoamer. Suitable defoamers include silicone or mineral oils. Preferably the defoamer is a mineral oil.

### Types of Packaging

The present disclosure further provides a method for printing images on a substrate comprising directing a stream of droplets of any of the embodiments of the ink composition of the invention onto a substrate and allowing the ink droplets to dry, thereby printing images on a substrate. Preferably, an inkjet printer such as a continuous inkjet printer is used in the method. Any suitable substrate may be printed in accordance with the invention.

The ink composition of the present invention is particularly suitable for printing on materials used for food packaging.

Examples of suitable substrates include metalized cans, plastic pots, retort pouches, and flexible plastic films. A substrate can include a surface that comprises, for example, LDPE, HDPE, polypropylene, PET, nylon or PVdC. Preferably, the substrate is a polyethylene substrate such as LDPE or HDPE.

### Methods and Uses

The ink compositions are formulated by combining the components using methods known in the art.

The present disclosure further provides a method for printing images on a substrate in a continuous inkjet printer comprising directing a stream of droplets of any of the embodiments of the ink composition to a substrate and allowing the ink droplets to dry, thereby printing images on a substrate. Any suitable substrate may be printed in accordance with the invention.

Examples of suitable substrates include non-porous substrates such as hard plastics, polymer films, polymer laminates, metals, metal foil laminates, glass, and ceramics. The paper substrates may be thin sheets of paper, rolls of paper, or cardboard. Plastics, laminates, metals, glass, and ceramic substrates may be in any suitable form such as in the form of bottles or containers, plates, rods, cylinders, etc.

Advantageously, using the compositions and methods described herein overcomes and/or mitigates at least some of the problems described above, providing an improved quality print.

### Definitions

As used herein the term printed deposit refers to the ink composition after it has been printed onto a suitable substrate. That is the ink composition of the present invention wherein at least some of the solvent has evaporated.

As used herein the term inkjet composition includes an inkjet ink composition suitable for use in inkjet printing. The ink composition is typically in the form of a liquid, and typically a solution.

As used herein the term offsetting refers to the process whereby a code or the like printed on a packaging substrate is transferred to an adjacent substrate. Typically this occurs during the retort process and is typically an undesirable effect.

As used herein the term C₁₋₆ alkyl alcohol refers to any solvent having at least one hydroxyl function group (—OH) and having between 1 and 6 carbon atoms.

As used herein the term polymer refers to any substance having a repeat unit and includes: polysaccharides and its derivative for example cellulose and its derivatives; addition polymers such as acrylic resins or polyvinyl resins; condensation polymer, for example polyurethanes, polyamide and polyesters; and co-polymers wherein the repeat unit is formed of two or more different compounds, for example of styrene and maleic anhydride.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### EXAMPLES

The following non-limiting examples further illustrate the present invention.

Print samples were created using a Domino Ax Series print sample rig fitted with a 60 μm nozzle. These were made on flexible food packaging substrates. Substrates tested include LDPE sheet, polywrap (polyethylene film), HDPE sheet, propafilm (polypropylene film), Nylon 6 sheet, PET laminated retort pouch, unplasticised PVC film, cellulose film, and TetraPak substrate. The sample were blank example substrates and did not include any printing ink for a particular food product.

The TetraPak substrate is a White Tetra Pak Aseptic multi-layered food packaging substrate containing a 10-12 um layer of LDPE on top of the white paper.

### Basic Composition

A range of example and comparative example compositions were prepared according to the general formulation shown below. It is preferable to use a top colorant in the ink compositions of the present invention. In many of the examples a top colorant is not used. This is to allow for evaluation of the indelible colorant migration and penetration.

TABLE 1
Basic Composition

| Component | Description | Wt % |
|---|---|---|
| MEK | Solvent | 85.5 |
| EtOH | Solvent | 5 |
| CAB553 | Binder | 5 |
| Citroflex A4 | Plasticiser | 3 |
| LiNO₃ | Conductivity | 1 |
| | Salt | |
| Solvent Black 27 | Top colorant | 0 |
| Indelible Dye | Indelible Dye | 0.5 |

In some instances the composition includes a top colorant, as described below. In some instances the binder is changed or removed, as described below. In cases where other components or different amounts of a component were used (e.g. a top colorant or more/less plasticizer was used), the amount of MEK was altered to reach 100 wt %. All other ingredients remained the same unless explicitly stated.

### Example Compositions

The colorants use as the indelible dyes in the example and comparative compositions are set out below.
SG 3=Solvent Green 3
SV 13=Solvent Violet 13
SB 35=Solvent Blue 35
DR 60=Disperse Red 60
SB 3=Solvent Black 3
SB 104=Solvent Blue 104
SR 23=Solvent Red 23
SR24=Solvent Red 24
SR 27=Solvent Red 27
SO 7=Solvent Orange 7
SBL5=Solvent Blue 5

TABLE 2
Example and Comparative Compositions

| | Example Number | | | | | | |
|---|---|---|---|---|---|---|---|
| | 1 | 2 | 3 | 4 | 5 | 6 | 7 |
| indelible dye | SG 3 | SV13 | SB35 | DR60 | SB3 | SB104 | SR23 |
| indelible dye M_{w} | 418.49 | 329.36 | 350.46 | 331.33 | 456.54 | 474.61 | 352.39 |
| binder | C553 | C553 | C553 | C553 | C553 | C553 | C553 |
| top colorant | n | n | n | n | n | n | n |
| plasticizer | y | y | y | y | y | y | y |
| | Example Number | | | | | | |
| | 8 | 9 | 10 | 11 | 12 | 13 | 14 |
| indelible dye | SR24 | SR27 | SO7 | SBL5 | SR24 | SR24 | SR24 |
| indelible dye M_{w} | 380.44 | 408.49 | 276.33 | 495.71 | 380.44 | 380.44 | 380.44 |
| binder | C553 | C553 | C553 | C553 | C553 | C553 | C553 |
| top colorant | n | n | n | n | y | n | n |
| plasticizer | y | y | y | y | y | n | 6.0 ppw |

| | Example Number | | | | |
|---|---|---|---|---|---|
| | 15 | 16 | 17 | 18 | 19 |
| indelible dye | SR24 | SR24 | SR24 | SR24 | SR24 |
| indelible dye M_{w} | 380.44 | 380.44 | 380.44 | 380.44 | 380.44 |
| binder | C553 | Hippol | Carboset | Hippol | Joncryl |
| | | LV 18 | 514A | LV 18 | 915 |
| top colorant | n | n | n | n | n |
| plasticizer | 11.5 ppw | y | y | y | y |

n = component not present; y = component is present; C553 is CAB553-0.4.

In Examples 12-21 changes to the basic composition were made.

In Example 12 the top colorant is present at 2.5 wt % amount relative to the components specified in Table 1.

In Example 13 no plasticiser Citroflex A4 was used.

In Example 14 plasticiser Citroflex A4 was used in 6.0 wt %

In Example 15 plasticiser Citroflex A4 was used in 11.5 wt %

In Example 16 Hipol was used in place of CAB553 at 5 wt %.

In Example 17 Carboset 514A (a low Tg binder was used) at 12.5 wt %. Here, the plasticiser Citroflex A4 was not present in the composition.

In Example 18 Hipol was used in place of CAB553 at 5 wt %. Here, the plasticiser Citroflex A4 was not present in the composition.

In Example 19 Joncryl 915 (a low Tg polymer) was used in place of CAB553 at 6.49 wt %. Here, the plasticiser Citroflex A4 was not present in the composition.

Example 1 (using solvent green 3) was very pale. As a result, the dye faded with time as it bled into the substrate and thus it was not possible to accurately carry out any colour measurements. However, visual inspection shows that the code for this example is blurred and fades.

### Glass Transition—Tg

Tg was calculated by the Fox equation (° C.). Tg of the binder was taken from information supplied by the supplier and the Tg of the plasticizer was taken from Harte et al (J. Applied Polymer Sci, 127, 2013, “The effect of citrate ester plasticizers on the Thermal and Mechanical properties of poly(DL-lactide)”).

Briefly, the the Fox equation is a formula that can be used to predict the T_{g} of a mixture, often a polymer mixed with a low molecular weight diluent or plasticizer. The Fox equation is shown below where w₁ and w₂ are weight fractions of components 1 and 2, respectively.

$$\frac{1}{{T}_{g}} = \frac{{w}_{1}}{{T}_{g , 1}} + \frac{{w}_{2}}{{T}_{g , 2}} .$$

### Printing

Example compositions 1 to 19 were tested by printing on a substrate. Print samples were created using a Domino Ax Series print sample rig fitted with either a 60 μm nozzle.

The substrate used was a white Tetra Pak Aseptic multi-layered food packaging substrate containing a 10-12 μm layer of LDPE on top of the white paper. The samples were blank example substrates and did not include any printing ink for a particular food product.

### Dye Migration (Blurring)

The migration distance is a measure of the spread of the ink from the original point of deposition across the surface of the substrate, often referred to as blurring.

Measurements by optical microscope and visual inspections were carried out on printed substrates.

To quantitatively evaluate the blurring of the ink by migration the follow method was used.

Drawdowns with 24 μm (approx. height of a printed drop) were made. Half of the substrate was covered with tape to give a sharp edge to the ink coverage. These were placed in a 25° C. chamber for 7 days

Images of the drawdowns were scanned in at 2400 dpi and analysed using the QEA software (https://www.qea.com/).

The L*a*b* values were measured at 0.02 mm increments from the edge of the ink code into the blank substrate and the colour change ΔE was calculated using equation 1:

ΔE*_{ab}=\sqrt{(L*₂−L*₁)²+(a*₂−a*₁)²+(b*₂−b*₁)²} (Equation 1)

The colour change was calculated at each point vs the blank substrate. The blank substrate was taken as the point 1.6 mm away from the edge of the coating.

These colour changes were then analysed and the distance at which the colour change dropped below ΔE=1 was taken as the point where migration stopped.

ΔE=1 was chosen as this is often the point where colour change is no longer considered visual to the naked eye.

Visually, migration by blurring is considered too great when the droplets of a printed code begin to join and become indistinguishable from each other.

The printed droplet size produced by the Domino Ax series printer fitted with a 60 μm nozzle is 0.4 mm. For example, using this printer set-up migration (blurring) in excess of 0.8 mm would be considered too much for a good quality image.

TABLE 3
Migration Measurements

| | Example Number | | | | | | |
|---|---|---|---|---|---|---|---|
| | 1 | 2 | 3 | 4 | 5 | 6 | 7 |
| Microscope | * | * | 47.00% | 33.44% | 4.33% | 20.97% | 41.22% |
| visual - 10 days | y | y | y | y | n | n | n |
| Visual - 3 weeks | y | y | y | some | n | n | some |
| Migration | ** | 1.36 | 0.88 | 0.68 | 0.38 | 0.64 | 0.66 |
| distance (in mm) | | | | | | | |

| | Example Number | | | | | | |
|---|---|---|---|---|---|---|---|
| | 8 | 9 | 10 | 11 | 12 | 13 | 14 |
| Microscope | 27.48% | 46.66% | 36.85% | 100.00% | — | — | — |
| visual - 10 days | n | n | y | n | — | — | — |
| Visual - 3 weeks | some | some | y | n | — | — | — |
| Migration | 0.66 | 0.5 | 1.08 | n/a | 0.5 | 0.48 | 0.7 |
| distance (in mm) | | | | | | | |

| | Example Number | | | | |
|---|---|---|---|---|---|
| | 15 | 16 | 17 | 18 | 19 |
| Migration | 0.52 | 0.48 | 0.48 | 0.4 | 0.52 |
| distance (in mm) | | | | | |

*Not measured due to poor contrast
**ink fades so much that not easily visualised so no measurements can be made

Microscope—blurring after 1 week at 25° C., based on microscope drop change.

The % was determined from the size of the droplet immediately after printing. Droplet size was measured for each ink at 50× magnification. In each case 5 or more drops were measured and averaged.

Then after 1 week storage in 25° C., the sample was tampered with MEK and then re-measured under optical microscope using a digital camera and software from Leica at 50× magnification.

It was visually determined where the edge of the droplet was and each ink was sample was measured at least 5 times and averaged. % drop growth was calculated as follows:

$$\% drop growth = \frac{Droplet size after - Droplet size before}{Droplet size before}$$

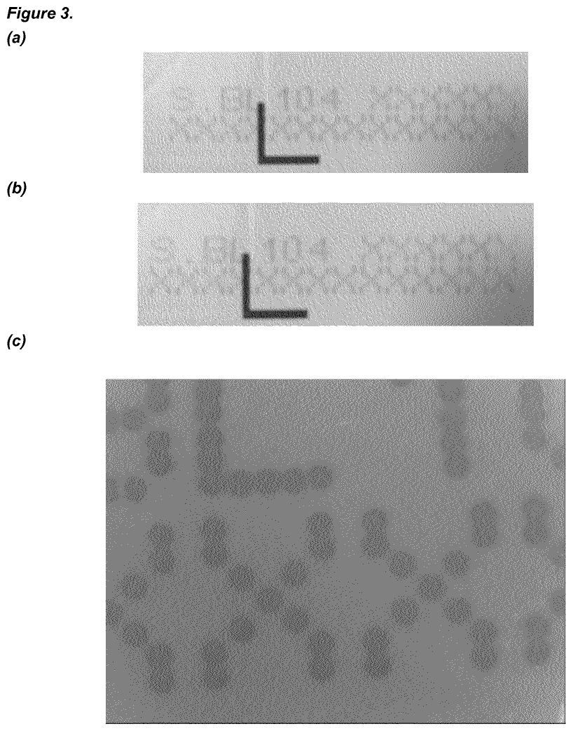

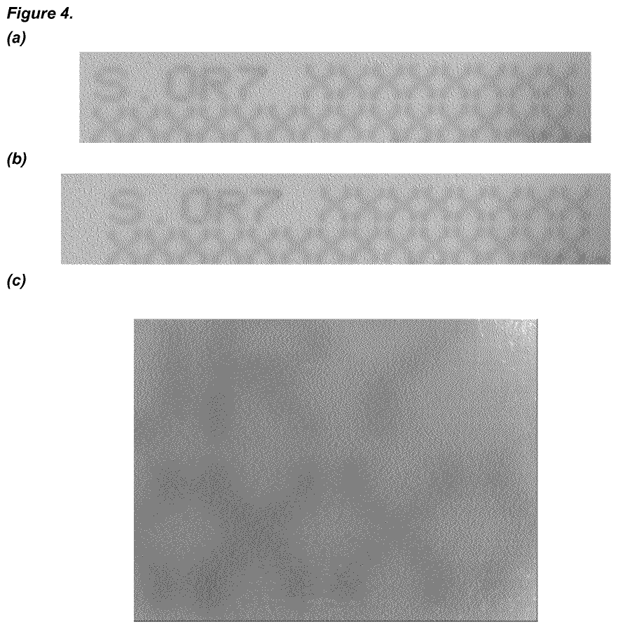

FIGS. 3 and 4 show images of the sample prints for Solvent Blue 104, Example 6 and Solvent Orange 7, Example 10 respectively. FIGS. 3(a) and 4(a) are the samples immediately after printing. FIGS. 3(b) and 4(b) are the samples after 7 days at 25° C. FIGS. 3(c) and 4(c) are microscope images of the samples after 3 weeks at 25° C.

Measurements carried out by optical microscope can be difficult. The point of change in contrast must be determined visually which can lead to subjectivity in the measurements and is also dependent on the colour of the dye. Quantitative measurement of blurring to give migration distance were therefore carried out.

Visual 10 days—This was a visual check of the text after 10 days at 25° C.

Visual 3 weeks—This was a visual check of the text after 3 weeks at 25° C.

Migration distance (in mm)—quantitative analysis of migration after 1 week at 25° C. from drawdowns with a blank portion of substrate as described in detail above.

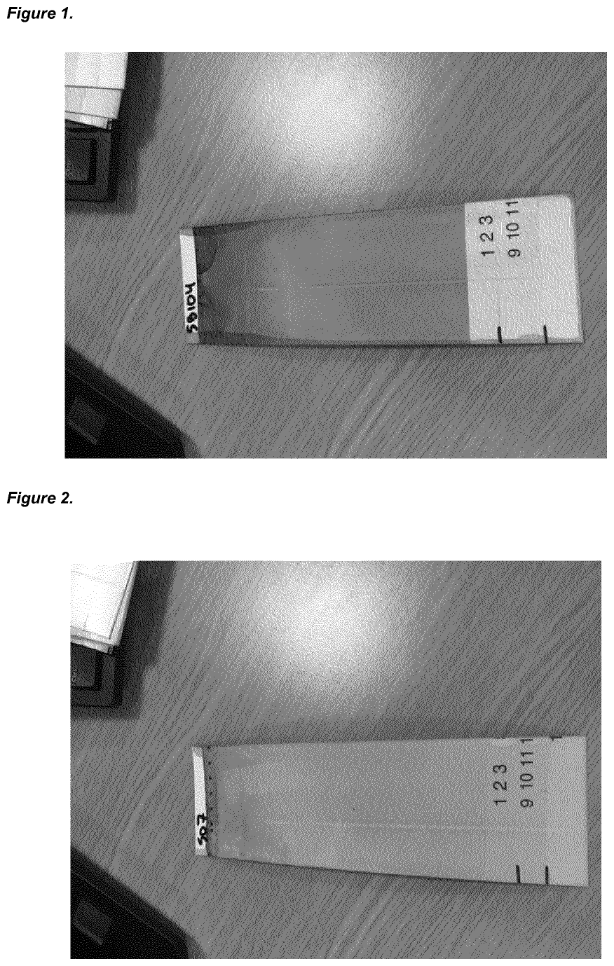

FIG. 1 shows a drawdown of Example 6 and FIG. 2 shows a drawdown of Example 10.

### Dye Indelibility

Indelibility refers to the movement of the ink to penetrate the substrate in the area under the original printed image (i.e. indelibility is not blurring). The amount of indelible colorant present in a substrate after printing was determined by optical measurements of the indelible colorant.

The method for determining indelibility of the example inks is as follows.

Drawdowns of the ink were made using a 24 μm drawdown bar on the blank Tetra Pak material. These were placed in a 25° C. chamber and left for a fixed amount of time depending on the measurement taken (1 hour, 1 day or 1 week)

The top layer of ink was removed using MEK (several wipes) and the colour was measured using an x-rite densiometer. The L*a*b* values and the optical density were recorded in triplicate at three different positions and averaged.

Colour change was calculated with respect to the blank substrate (measured in the same way) according to equation:

ΔE*_{ab}=\sqrt{(L*₂−L*₁)²+(a*₂−a*₁)²+(b*₂−b*₁)²} (Equation 1)

Optical density change was calculated with respect to the top, unaltered ink film according to equation 2:

$$Optical Density Change = \frac{\begin{matrix}Optical density of top code - \\ Optical density of tampered code\end{matrix}}{\begin{matrix}Optical density of top code - \\ Optical density of blank substrate\end{matrix}} \qquad ( Equation 2 )$$

TABLE 4
Penetration Measurements

Example Number

| | | | | | | |
|---|---|---|---|---|---|---|
| 1 | 2 | 3 | 4 | 5 | 6 | 7 |

Colour change

| | | | | | | | |
|---|---|---|---|---|---|---|---|
| Tg | 9.08 | 9.08 | 9.08 | 9.08 | 9.08 | 9.08 | 9.08 |
| top code | 18.1990905 | 33.61087 | 57.42056 | 68.90419 | 58.4891 | 47.5577 | 46.6482 |
| 1 hr | 6.163250464 | 23.15857 | 31.81263 | 19.44752 | 2.84362 | 12.9953 | 47.7794 |
| 1 d | 11.26030733 | 27.82128 | 49.06706 | 45.87832 | 14.1795 | 16.672 | 37.7749 |
| 1 wk | 14.47410461 | 26.68376 | 50.34088 | 55.74259 | 25.2224 | 18.2119 | 36.306 |

Optical Density Change from Blank after Storage

| | | | | | | | |
|---|---|---|---|---|---|---|---|
| top code* | 0.186311111 | 0.256633 | 0.746489 | 0.762156 | 1.04081 | 0.52318 | 0.4688 |
| 1 hr | 8.68% | 53.74% | 41.00% | 14.22% | 0.15% | 14.42% | 93.51% |
| 1 d | 40.82% | 71.29% | 74.80% | 49.98% | 10.85% | 21.33% | 67.62% |
| 1 wk | 58.74% | 67.21% | 77.17% | 68.28% | 27.84% | 24.29% | 63.20% |

| Example Number | | | | | | |
|---|---|---|---|---|---|---|
| 8 | 9 | 10 | 11 | 12 | 13 | 14 |

Colour change

| | | | | | | | |
|---|---|---|---|---|---|---|---|
| Tg | 9.08 | 9.08 | 9.08 | 9.08 | 9.08 | 132.00 | −25.12 |
| top code | 63.7687 | 80.6281 | 73.1016 | 80.583321 | 87.58602 | 65.2243 | 65.9056 |
| 1 hr | 48.5594 | 57.0034 | 56.8469 | 0.343609 | 38.62943 | 9.91773 | 43.6084 |
| 1 d | 54.5708 | 70.5641 | 64.1282 | 0.3592867 | 52.23859 | 17.3123 | 56.1997 |
| 1 wk | 57.4051 | 73.242 | 66.9164 | 0.6103083 | 57.07646 | 24.8283 | 61.0098 |

Optical Density Change from Blank after Storage

| | | | | | | | |
|---|---|---|---|---|---|---|---|
| top code* | 0.75007 | 1.17011 | 0.8507 | 1.2594889 | 1.988656 | 0.78638 | 0.77866 |
| 1 hr | 60.89% | 50.49% | 72.01% | 1.50% | 16.48% | 5.00% | 50.25% |
| 1 d | 73.25% | 73.88% | 84.41% | 1.59% | 25.77% | 13.48% | 74.15% |
| 1 wk | 79.15% | 79.31% | 88.70% | 1.18% | 29.59% | 22.16% | 84.13% |

| Example Number | | | | |
|---|---|---|---|---|
| 15 | 16 | 17 | 18 | 19 |

Colour change

| | | | | | |
|---|---|---|---|---|---|
| Tg | −49.24 | | 28.00 | | 13.00 |
| top code | 69.0444 | 73.29247 | 62.59396 | 74.1699 | 72.4301 |
| 1 hr | 36.5503 | 46.73407 | 16.28728 | 48.1589 | 10.7033 |
| 1 d | 52.1801 | 62.07297 | 21.11025 | 64.8017 | 12.4465 |
| 1 wk | 63.6249 | 63.26999 | 28.0522 | 70.4907 | 12.9884 |

Optical Density Change from Blank after Storage

| | | | | | |
|---|---|---|---|---|---|
| top code* | 0.84528 | 0.960711 | 0.738656 | 0.9569 | 0.932 |
| 1 hr | 35.89% | 44.88% | 12.95% | 48.15% | 4.38% |
| 1 d | 60.60% | 71.03% | 19.01% | 76.10% | 6.61% |
| 1 wk | 83.38% | 72.76% | 28.33% | 87.12% | 7.00% |

*The value provided for the top coat after storage is a change in optical density (rather than a % change)

### Examples 77 and 78

The following example compositions were prepare and tested for penetration on a range of substrates. Optical density measurements were carried out as described above for Examples 1 to 19.

TABLE 5
Compositions for Distribution Study with Different Substrates

Example Number

| | |
|---|---|
| 77 | 78 |

| | | |
|---|---|---|
| | | Relative Amount |
| Component | Description | by Weight (ppw) |

| | | | |
|---|---|---|---|
| MEK | Solvent | 68.19 | 68.19 |
| EtOH | Solvent | 14.66 | 14.66 |
| CAB553 | Binder | 5.30 | 5.30 |
| Dertophene T | Tackifier/binder | 1.00 | 1.00 |
| Tego Variplus CA | Binder | 0.30 | 0.30 |
| Citroflex A4 | Plasticiser | 3.00 | 3.00 |
| Tego Glide 410 | Surfactant/additive | 1.00 | 1.00 |
| Tytan AP100 | Crosslinker | 3.00 | 3.00 |
| LiNO₃ | Conductivity Salt | 0.80 | 0.80 |
| Solvent Black 29 | Top colorant | 2.25 | — |
| Solvent Black 27 | Top colorant | — | 2.25 |
| Solvent Blue 104 | Indelible Dye | 0.50 | 0.50 |

CAB553 has a Tg of 136° C.
Dertophene T, a Terpene phenolic ester of approx. Mw of 700, has a Tg of 48° C.
Tego Variplus CA, a ketone-aldehyde condensation resin, has a Tg of 75° C.

TABLE 6
Optical Density Data for Example 77
Example 77

| | Substrate | | | | |
|---|---|---|---|---|---|
| Sample | Tetra Pak-W | EloPak-1 | Yongfa-1 | Yongfa-3 | Fenmei-2 |
| Blank | 0.112 | 0.117 | 0.098 | 0.102 | 0.091 |
| Substrate | | | | | |
| After | 2.375 | 2.273 | 2.246 | 2.155 | 2.237 |
| Printing | | | | | |
| Removed | 0.187 | 0.234 | 0.209 | 0.176 | |
| after 1 | | | | | |
| hour | | | | | |
| Change | 0.089 | 0.147 | 0.144 | 0.117 | |
| after 1 | | | | | |
| hour | | | | | |
| Removed | 0.285 | 0.413 | 0.363 | 0.345 | |
| at 1 | | | | | |
| day | | | | | |
| Change | 0.205 | 0.373 | 0.346 | 0.386 | |
| after 1 | | | | | |
| day | | | | | |
| Removed | 0.354 | 0.349 | 0.369 | 0.291 | 0.296 |
| at 1 | | | | | |
| week | | | | | |
| Change | 0.334 | 0.439 | 0.482 | 0.463 | 0.357 |
| after 1 | | | | | |
| week | | | | | |

TABLE 7
Optical Density Data for Example 78
Example 78

| | Substrate | | | | |
|---|---|---|---|---|---|
| Sample | Tetra Pak-W | EloPak-1 | Yongfa-1 | Yongfa-3 | Fenmei-2 |
| Blank | 0.112 | 0.117 | 0.098 | 0.102 | 0.091 |
| Substrate | | | | | |
| After | 2.240 | 2.210 | 2.240 | 1.969 | 2.304 |
| Printing | | | | | |
| Removed | 0.198 | 0.187 | 0.225 | 0.192 | 0.194 |
| after 1 | | | | | |
| hour | | | | | |
| Change | 0.102 | 0.089 | 0.165 | 0.143 | 0.125 |
| after 1 | | | | | |
| hour | | | | | |
| Removed | 0.333 | 0.378 | 0.383 | 0.349 | 0.351 |
| at 1 | | | | | |
| day | | | | | |
| Change | 0.261 | 0.328 | 0.372 | 0.394 | 0.314 |
| after 1 | | | | | |
| day | | | | | |
| Removed | 0.388 | 0.382 | 0.478 | 0.389 | 0.468 |
| at 1 | | | | | |
| week | | | | | |
| Change | 0.319 | 0.386 | 0.497 | 0.457 | 0.455 |
| after 1 | | | | | |
| week | | | | | |

1. An inkjet composition for printing onto a substrate, the composition comprising an indelible colorant, one or more solvents, and a binder, optionally also containing a plasticizer and/or a conductivity additive, wherein the migration distance of the indelible colorant in the substrate is less than 0.85 mm after 7 days at 25° C.

2. The inkjet composition according to claim 1, wherein the indelible colorant does not predominately reside in the substrate.

3. The inkjet composition according to claim 1, wherein the indelible colorant has a non-planar arrangement.

4. The inkjet composition according to claim 1, wherein the indelible colorant has two aromatic groups, and the aromatic groups are in a non-planar arrangement.

5. The inkjet composition according to claim 1, wherein the indelible colorant is selected from an anthraquinone dye and an azo dye.

6. The inkjet composition according to claim 1, wherein the indelible colorant is selected from the group consisting of Solvent Black 3, Solvent Blue 97, Solvent Blue 104, Solvent Red 23, Solvent Red 24, Solvent Red 27, Disperse Red 60 and 1 (4 Dodecylanilino)anthraquinone.

7. The inkjet composition according to claim 1, wherein the composition further comprises a top colorant.

8. The inkjet composition according to claim 7, wherein the indelible colorant is not Solvent Blue 97 or Solvent Red 23, or a combination thereof used in combination with a top colorant selected from Solvent Black 29 or Pigment Black 7.

9. The inkjet composition according to claim 7, wherein the top colorant is selected from a metal complex dye and a pigment-based colorant.

10. The inkjet composition according to claim 7 , wherein the top colorant is selected from Pigment Black 7, Solvent Black 27 and Solvent Black 29.

11. The inkjet composition according to claim 1, wherein the composition further comprises a binder or a binder plasticizer combination having a Tg of no more than 25° C.

12. A method of printing, the method comprising the step of directing a stream of droplets of an inkjet composition according to claim 1 on to a substrate and allowing the ink droplets to dry, thereby printing images on the substrate.

13. The method of claim 12, wherein the substrate is selected from LDPE, HDPE, polypropylene, PET, nylon or PVdC,

14. The method of claim 13, wherein the substrate is LDPE or HDPE.

15. The method of claim 14 wherein the substrate is LDPE.

16. A printed deposit that is obtained or obtainable from the method of claim 12, wherein the indelible colorant does not predominately reside in the sub state,
with the proviso that the printed deposit is not a printed deposit obtained or obtainable from printing an inkjet composition comprising methyl ethyl ketone (MEK) at 74.88 wt %, ethanol at 8.32 wt %, CAB-553-0.4 at 5.30 wt %, Dertophene T at 1.00 wt %, Tego Variplus CA at 0.30 wt %, Citroflex A4 at 2.80 wt %, Tego Glide 410 at 1.00 wt %, Tytan AP100 at 3.00 wt %, LiNO3 at 0.65 wt %, Duasyn Black-A-RG (Solvent Black 27) at 2.25 wt % and Solvaperm Blue 2B (Solvent Blue 104) at 0.50 wt %.

17. The inkjet composition according to claim 3, wherein the non-planar arrangement is more energetically favorable than a planar arrangement of the indelible colorant.

18. The inkjet composition according to claim 1, wherein the composition further comprises a binder or a binder plasticizer combination having a Tg of no more than 12° C.
